(19) United States
(12) Patent Application Publication
(10) Pub. No.: US 2009/0313582 A1
(43) Pub. Date: Dec. 17, 2009

(54) System, Method and Computer Program for User-Friendly Social Interaction

(76) Inventors: Raul Rupsingh, Brampton (CA); Stephen Seath, London (CA)

Correspondence Address: MILLER THOMPSON, LLP, Scotia Plaza, 40 King Street West, Suite 5800, TORONTO, ON, M5H 3S1, CA

(21) Appl. No.: 12/240,351

(22) Filed: Sep. 29, 2008

Related U.S. Application Data
(60) Provisional application No. 61/129,214, filed on Jun. 11, 2008.

(51) Int. Cl. G06F 3/048

(52) U.S. Cl. 715/835

(57) ABSTRACT

The present invention, in one aspect thereof, provides a computer interface whose primary directive is uncompromising simplicity and ease of use by providing a carefully selected subset of features most desirable by a new computer user. The invention teaches a method, system and computer program for navigating a software interface comprising the steps of: (a) a user being provided with one or more input means to a computer, the software interface being loaded on the computer, and the user interacting with the software interface using the one or more input means; (b) the software interface displaying one or more program options to the user, such program options being of a number manageable to the user, and each program options being represented by a readily identifiable icon that enables navigation of the program options; (c) the user selecting at most one of the program options by selecting the corresponding readily identifiable icon, the selected program option corresponding to one of a plurality of active programs, each active program represented by a consistent layout; (d) the software interface displaying one or more basic commands each relating to the active program, the basic commands each represented by a readily identifiable command icon; and (e) the user selecting one of the basic commands or returning to the display of the limited number of program options.

### PRIORITY CLAIM

This application claims priority to U.S. provisional patent application 61/129,214 filed Jun. 11, 2008.

### FIELD OF THE INVENTION

The present invention relates generally to providing an accessible user interface for a communication utility. The present invention more specifically relates to a communication utility providing a user-friendly interface particularly for the elderly and those with attenuated abilities.

### BACKGROUND TO THE INVENTION

The present invention stems from several converging trends in a large population of users left behind by the computer age. This digital divide derives from the increasing number of features and corresponding complexity in today's technology. The largest user group within this audience is 40 million seniors, and 36,500 assisted living residences in North America alone. The population aged 65+ is expected to double by 2030 and polls have found that over 50% of seniors find existing computer interfaces difficult to use.

Today, novice computer users, particularly seniors, are increasingly drawn towards using computers for the first time in their lives because broadband internet connectivity and cheaper technology has enabled families to connect online more than ever before. Families now own digital cameras and use email to communicate and share photos online. Users inexperienced with computers increasingly see the relevance of the technology but find the learning curve very intimidating.

The last relevant market trend related to this invention is that computer hardware, particularly ease-of-use technologies like touch screens, are now affordable. $500 PC's are now commonplace and $500, 19″ touch-screens are now available, having fallen in price by 50% in 2007 alone.

The digital divide affects not only seniors but also people with attenuated abilities, such as those with decreased visual acuity, or who have neurological deficits that make conventional computer communication devices difficult to learn or use. As exceptions to this, specialized devices and software were developed to assist those with extreme neurological or physical handicaps. Such systems are quite expensive, however, and are therefore out of reach for the overwhelming majority of people who need access to effective computer-facilitated systems and equipment that can be provided to virtually anyone of even modest means, and can be implemented by friends or family members having basic computer skills.

Another approach to bridging the digital divide between technology and inexperienced computer users has been tutorials and classes that attempt to teach computer paradigms to users. This approach underestimates the complexity of computer abstractions. The system moves in the opposite direction of changing the technology and building it for novice computer users. Other approaches recognize the need but fill the gap using alternative technology such as email through fax machines or present a software interface that is simpler than a typical operating system such as Windows™, but still provides all the features and complexity of complex computer programs such as Microsoft™ Office™.

Therefore, what is required is an approach for providing novice computer users and users with attenuated abilities. What is also required is an approach for doing so at a cost low enough to be practicable for most users that do not desire to spend large amounts to learn to use a computer, which they otherwise believe has limited benefit to them.

### SUMMARY OF THE INVENTION

In one aspect of the present invention, a method for navigating an interface of a computer program is provided, the method comprising the steps of: (a) a user being provided with one or more input means to a computer, the computer program being executed on the computer, and the user interacting with the interface of the computer program using the one or more input means; (b) the interface displaying one or more program options to the user, such program options being of a number manageable to the user, and each program option being represented by a readily identifiable program icon that enables navigation of the program options, the readily identifiable program icon being of a size substantially larger than a typical computer icon; (c) the user selecting at most one of the program options by selecting the corresponding readily identifiable program icon, the selected program option corresponding to one of a plurality of active programs, each active program represented by a consistent layout; (d) the interface displaying one or more basic commands to the user, such commands being of a number manageable to the user, each basic command relating to the active program, the basic commands each represented by a readily identifiable command icon, the readily identifiable command icon being of a size substantially larger than a typical computer icon; and (e) the user selecting at most one of the basic commands or returning to the display of the limited number of program options.

In another aspect of the present invention, a system for navigating an interface of a computer program is provided, the system comprising: (a) one or more input means to a computer, the computer program being executed on the computer, and a user interacting with the interface of the computer program using the one or more input means; (b) one or more program options displayed to the user by the interface, such program options being of a number manageable to the user, and each program option being represented by a readily identifiable program icon that enables navigation of the program options, the readily identifiable program icon being of a size substantially larger than a typical computer icon; (c) a plurality of active programs, each active program represented by a consistent layout, the user selecting at most one of the program options by selecting the corresponding readily identifiable program icon, the selected program option corresponding to one of active programs; and (d) one or more basic commands displayed to the user by the interface, such commands being of a number manageable to the user, each basic command relating to the active program, the basic commands each represented by a readily identifiable command icon, the readily identifiable command icon being of a size substantially larger than a typical computer icon; wherein the user selects at most one of the basic commands or returns to the display of the limited number of program options.

In a further aspect of the present invention, a computer program product for navigating an interface of a computer program is provided, the computer program product comprising: (a) a computer readable medium including software instructions; and (b) the software instructions for enabling the computer to perform predetermined operations, the predetermined operations including the steps of: (i) a user being provided with one or more input means to a computer, the computer program being executed on the computer, and the user interacting with the interface of the computer program using the one or more input means; (ii) the interface displaying one or more program options to the user, such program options being of a number manageable to the user, and each program option being represented by a readily identifiable program icon that enables navigation of the program options, the readily identifiable program icon being of a size substantially larger than a typical computer icon; (iii) the user selecting at most one of the program options by selecting the corresponding readily identifiable program icon, the selected program option corresponding to one of a plurality of active programs, each active program represented by a consistent layout; (iv) the interface displaying one or more basic commands to the user, such commands being of a number manageable to the user, each basic command relating to the active program, the basic commands each represented by a readily identifiable command icon, the readily identifiable command icon being of a size substantially larger than a typical computer icon; and (v) the user selecting at most one of the basic commands or returning to the display of the limited number of program options.

In yet another aspect of the present invention, a system for distributing and remotely configuring a computer program is provided, the system comprising: (a) a server operated by a service provider, the server making available the computer program via remote download; (b) an enabling intermediary, familiar with a user, the enabling intermediary initiating a download of the computer program from the server, the enabling intermediary paying a fee to the service provider; (c) a first computer belonging to the user, the enabling intermediary installing the computer program on the first computer; and (d) a remote access utility enabling the enabling intermediary to remotely configure the computer program from a second computer.

In a further still aspect of the present invention, a method for distributing and remotely configuring a computer program is provided, the method comprising: (a) a server making available the computer program via remote download, the server operated by a service provider; (b) an enabling intermediary initiating a download of the computer program from the server, the enabling intermediary being familiar with a user, the enabling intermediary paying a fee to the service provider; (c) the enabling intermediary installing the computer program on a first computer, the first computer belonging to the user; and (d) the enabling intermediary remotely configuring the computer program from a second computer using a remote access utility.

### BRIEF DESCRIPTION OF THE DRAWINGS

FIG. 1 illustrates the homepage of the present invention, in one aspect thereof.

FIG. 2 illustrates the mail selection screen of the present invention, in one aspect thereof.

FIG. 3 illustrates an email reader of the present invention, in one aspect thereof.

FIG. 4 illustrates an email reader of the present invention, in one aspect thereof, wherein an email contains attached photos.

FIG. 5 illustrates an email reader of the present invention, in one aspect thereof, wherein an email contains an URL.

FIG. 6 illustrates a system prompt of the present invention, in one aspect thereof, wherein Central Figure has the option of sending an email by typed message or by voice.

FIG. 7 illustrates an email writer of the present invention, in one aspect thereof.

FIG. 8 illustrates the computer program of the present invention, in one aspect thereof, wherein a user is prompted to record a voice message.

FIG. 9 illustrates the computer program of the present invention, in one aspect thereof, wherein a user is instructed that it is recording a voice message.

FIG. 10 illustrates the computer program of the present invention, in one aspect thereof, wherein a user is instructed that it has completed recording a voice message.

FIG. 11 illustrates the computer program of the present invention, in one aspect thereof, wherein the system is operable to play back a recorded voice message.

FIG. 12 illustrates an email reader of the present invention, in one aspect thereof, wherein a user may listen to a received voice message.

FIG. 13 illustrates an email writer of the present invention, in one aspect thereof, wherein a user is replying to a received message.

FIG. 14 illustrates a visual address book of the present invention, in one aspect thereof.

FIG. 15 illustrates a whitelist mail response of the present invention, in one aspect thereof.

FIG. 16 illustrates a validation website provided by the service provider in accordance with the present invention, in one aspect thereof.

FIG. 17 illustrates a validation confirmation website in accordance with the present invention, in one aspect thereof.

FIG. 18 illustrates a photo selection tool in accordance with the present invention, in one aspect thereof.

FIG. 19 illustrates a means for introducing the system of the present invention to further persons, in accordance with the present invention, in one aspect thereof.

FIG. 20 illustrates an internet portal in accordance with the present invention, in one aspect thereof.

FIG. 21 illustrates an internet browser of the present invention, in one aspect thereof.

FIG. 22 illustrates a photo viewer of the present invention, in one aspect thereof.

FIG. 23 illustrates a games interface of the present invention, in one aspect thereof.

### DETAILED DESCRIPTION

### Overview

The present invention may be directed toward addressing heretofore unmet needs. In one aspect of the present invention, the systems, computers, methods, devices, hardware and software may have broad application in providing the desired communications systems, means and methods to a target population as described below. In another advantageous aspect, these may be provided at economic prices, and advantageously can be used on top of existing commodity computer equipment, devices and systems.

The present invention, in one aspect thereof, provides a computer interface whose primary directive is uncompromising simplicity and ease of use by providing a carefully selected subset of features most desirable by a new computer user. The methods, system, and computer program of the present invention take an approach to achieving simplicity that has not been contemplated in the prior art, that is, removing all extraneous functions of a particular software program to provide only basic functions, removing the ability to multitask to enable a user to interact with the particular software program in a linear manner, and providing only basic navigation functions. This is counter intuitive to those skilled in the art, who are focused on adding more and more features and further processing ability, which may be desirable for a typical computer user but not for the target user of the present invention.

The present invention relates to software, hardware, devices, networks, systems, and communications and business methods for providing, managing and operating a computer facilitated social communications system directed to providing user-friendly systems that are adapted and arranged to facilitate communications with a user (also referred to herein as Central Figure), and among a group of people. The Central Figure may typically be a senior or someone with attenuated visual, neurological or developmental capacities.

The attenuated target population for the present invention may include senior citizens, those with communications or physical disabilities (such as stroke, arthritis, cerebral palsy), those with low literacy levels or who speak English (or other language, as applicable) as a second language (ESL), those who have learning disabilities or cognitive impairments (such as MCI or dementia), and those with little or no experience in using computerized devices as communications tools. The system of the present invention, in one aspect thereof, may also have applications in developing nations where technology is being quickly adopted by individuals with relatively low language and technological literacy. Systems and methods of the present invention, in one aspect thereof, may be facilitated primarily via key software suites, and may be adapted and arranged to provide user-friendly communications to users of the system in the target population. The present systems may be used in conjunction with any computerized device comprising a video screen, such as a desktop computer or a client terminal, a “smart phone” or a laptop computer.

The system of the present invention, in one aspect thereof, allows users to use technology semi to fully autonomously by presenting software using plain English (or other language, as applicable) language and removing computer abstractions. The navigation procedure of the system may also be simple enough that it is operable even with no prior memory of the system, which is particularly relevant to users with cognitive impairments.

As previously described, the target user of the present invention may typically unfamiliar with using a computer. Thus, in another aspect of the present invention, an Enabling Intermediary, typically being a person highly familiar with the Central Figure, configures and manages the overall system and possesses the Supervisory Password. Typically, the Enabling Intermediary is the person who has purchased the system software and has installed it on the computer of the Central Figure and others.

As one of skill in the art will comprehend, many embodiments, permutations, modifications and variations of the invention fall within the present description and disclosure. It should also be understood that while the present specification uses the English language as the medium for an interface, in one aspect of the present invention, any language could be substituted for English in the applicable circumstances.

### System Architecture Overview

The present invention, in one aspect thereof, is a standalone program boot-loaded on top of a standard operating system (OS) on a desktop computer or mobile device. Thus the system may be designed to provide inexperienced computer users with a consistent interface and software experience that is not complicated by the computer abstractions found within the OS, internet browsers and the like. However, software applications running on a client machine have a larger footprint, require more configuration and hence are a more difficult technology to adopt. Hence, the present invention, in another aspect thereof, is a web application that runs inside a standard web browser. Modern web browsers are typically designed to allow web applications to run in full screen mode, and hence can provide a sufficiently immersive user experience. Moreover, modern web programming languages typically now support more advanced features such as voice recording and text to speech with reasonable performance, allowing the system to operate with similar functionality online.

The system of the present invention, in one aspect thereof, executes on a client machine that communicates with a central server. The client machine may act as an email client, photo browser, games portal and/or internet browser. The client machine may operate in single user mode or in a multi-user mode for institutions.

Users inexperienced with computers often do not have an email account or have one that is unused. The present invention, in one aspect thereof, automatically creates an email address for the new user and builds this email into the client application. Hosting the email account may enable the system to have full control over how it is maintained, backed up and utilized. The client application may send and receive mail by communicating with the system's email server, in any method known to those skilled in the art. State information about the user's account, including contacts in the user's address book, bookmarks made on the internet and emails they have read, deleted and responded to may all be stored in the user's email account for easy synchronization and restoration of account information later.

The client software may also maintain a separate license email account of its own. The server may be operable to push commands such as deleting a user, forcing synchronization of accounts or upgrading the program through email messages. These can be implemented by the administrator sending a coded email message to the license email account to enable the execution of these commands, as is known to those skilled in the art. The license email account may be used to provide access to the server to periodically query for software updates and to enable special commands such as deleting a user, forcing synchronization of accounts with the server, and making changes to program settings. The license email account may also serve as an identification means for the server. For example, on startup of the computer program of the present invention, the client machine and server may use the license email account'to determine which users are associated with the particular license, and to create or remove users on the client. Furthermore, when a new user is created, all of that user's information may be downloaded from the server (including name, email, email password, and login password, as applicable). The license email account also provides a means for synchronization including marking messages as read, deleted, replied to, etc. or to store newly created bookmarks and contacts. Finally, the license email account can enable the communication to the server about a particular user's usage information, computer program version information, and internet connectivity status.

The present invention, in one aspect thereof, provides numerous configuration choices, remote management by one or more authorized persons, and urgent need features, many of which are absent in conventional computerized devices now available to members of the target population. Remote management, for example, may be a set of online tools enabling the user's family and friends (the Enabling Intermediary and members of the Contact Group) to manipulate aspects of the client program remotely. This is further described more fully below.

The present invention, in another aspect thereof, is a system for improving and simplifying outgoing communication in the form of configurable emergency help requests sent at the press of a button to friends and family. Alternatively, this feature could be provided by a simple status update feature that can be set by a user and read or pushed to members of the Contact Group, as described more fully below.

Yet a further key aspect of the present invention, in one aspect thereof, is the removal of all unnecessary computer abstractions. This may significantly reduce the learning curve for inexperienced computer users or users with learning disabilities. The simplicity of the interface and usability of the application, rather than aesthetics or efficiency, may be regarded as the foremost feature of its design. This is more fully described below.

### Simplified Software Interface

As described above, the simplicity of the interface of the present invention, and usability of the application, rather than aesthetics, may be regarded as the foremost feature of its design.

Generally, the interface of the present invention may include any or all of the following characteristics for increasing its simplicity and/or usability: non-serif fonts, large fonts (for example, greater than 28 pt), and a consistent interface using relatively large buttons (for example, multiple times the size of a typical desktop icon). Computer novices are typically not as adept at searching a screen for what feature to use and often need careful guidance and prompting. Thus, it may be beneficial to only present a set of features that are absolutely necessary and requested, and each screen may present a minimalist set of options. Specific implementations of this design technique are described more fully below.

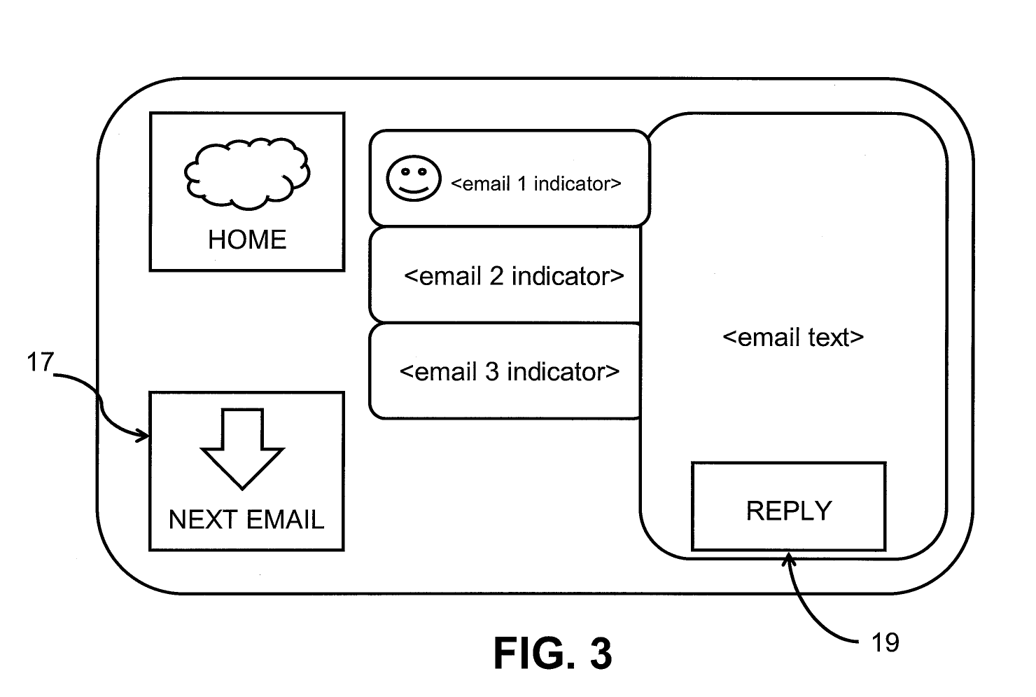

Another potential exclusion from the interface of the present invention may be specific computer abstractions that are difficult to use and unintuitive for a novice computer user, such as scroll bars, which allow for fine and coarse control but are often exceedingly small and can be physically challenging to operate. These may be replaced with large directional buttons, for example, as illustrated in FIG. 3. For example, as soon as a user exceeds a page (or screen) of written text, a “Previous Page” button may be provided to view previously typed text. Similarly, if the user does hit the “Previous Page” button, and is on for example, Page 2 of 3, a “Next Page” button may be displayed to enable the user to return to the next page, which is Page 3 of 3 in this example. When the user starts typing, the display may automatically go to the last page.

Yet another interface element that may be removed is the differential use of inputs such as mouse clicks. Users who have never operated a mouse or who have a physical disability may have trouble with left clicking, right clicking, double clicking and learning what circumstances to do all of these tasks. In the interface provided by the present invention, in one aspect thereof, any and all clicks or combination of clicks may have the same effect, reducing the learning curve. Similar approaches may be used for input devices such as touch screens or voice commands.

Furthermore, the use of software buttons may be simplified according to specific principles. All buttons may be designed and arranged to be absolutely or relatively consistent in terms of size, shape, location and animation. One example of this is the use of a consistently sized home button in a particular location, such as the upper left hand corner, of every form (except the homepage, since such a link is nonfunctional), to serve as a constant anchor for the user. Question/answer buttons may be always placed in the same position on the screen using a consistent and simple prompting method. For example, all prompts could be made to be answerable with a binary “Yes” or “No” and each prompt could provide the options consistently, such as “Yes” on the left and “No” on the right. A gradient may also be used to add color and the appearance of depth, but text may always be portrayed using black text on a white background, providing the best visual contrast and legibility. Buttons may also be designed to offer a text descriptor of a certain size (such as ⅙ of the screen) or greater. Buttons may also notify the user visually when there is a mouse-over event, such as providing the negative of its typical color scheme. Users may also be provided with visual and/or aural alerts when buttons are selected (depressed). For example, buttons may change colors in an alternating manner to help capture the user's visual attention, and the alert may last for a predetermined time following selection of the button (for example, 2 seconds after the event). Generally, buttons may be clear, colorful and non-technical in nature in order to be as simple as possible to understand and use.

A yet further typical complication in user interfaces is the use of multimodal windows and dialogs that overlap and present data to the user in pseudo-three dimensional space. These windows are often presented with controls in their upper corners and often confuse users who do not understand where these screens came from, where they are going, or what their purpose is. As is more fully described below, the present invention, in one aspect thereof, presents all material within a single full screen application in which the content and decision making elements of the application are navigated in a linear fashion. This may be inefficient for conventional interfaces but may significantly reduce the learning curve for inexperienced users.

Conventional computer interfaces are built for multi-tasking. However, multi-tasking may require agile thinking and spatial awareness of computer paradigms. The present invention, in one aspect thereof, reduces the complexity of the system by presenting the least amount of information at a given point in time. For example, when the user chooses to check their mail they may be presented with the simple of choice of whether they want to read or write mail. When they are reading mail they may be presented with a large document representing a single page of a single email.

Other computer abstraction that has been removed from the design may include the use of files, folders, recycle bins, hyperlinks, the desktop and computer applications such as web browsers. Files and folders represent a data abstraction and storage mechanism that often confuse users who need to save file attachments with a name and location while remembering the location for later retrieval.

In the present invention, however, photos and other attachments such as media files, and documents, may be automatically detected inside email messages, downloaded onto the computer, and stored in a linear list based on date received. Access to a large number of photos and other files may be simplified by organizing by both date and the contact that sent the file, rather than creating the folder abstraction. The concept of deleting an item may be used, but without the added concept of a recycling bin or restoring procedure.

Hyperlinks may be replaced with the familiar button concept.

The desktop and operating system interaction may also be replaced by a boot-loaded full-screen (or optionally, partial screen) application that serves as a portal to important functions such as browsing the internet.

Relative to a typical email reader, this removal of abstractions may provide a much easier to use email reader, that may also embed advanced items directly into the email along with instructional text to make it easy for the novice computer user. Using the example described above, wherein photos and other files are not included as attachment files to be manually saved as files onto a user's hard drive, they may be instead automatically downloaded onto the user's computer, and a small preview of the image or an icon representing the file may be shown on a button created inside the email with instructional text in proximity to or on the button telling the user what to do to view the photo or other file. A similar approach may be taken for URLs sent inside an email, since the novice user may not understand what a website URL is, or how to go from there to an internet browser. Annotative text describing the content inside an email and instructions on how to view it, as well as assistive buttons, may be embedded inside the email content to make comprehension and utilization easier.

For example, in one aspect of the present invention wherein an email adaptation is provided, there may be no subject line. This important aspect of the present invention addresses functional issues wherein inexperienced computer users may become confused about where they are typing, and do not easily comprehend how a subject of a message functions in a computerized system. Thus a particular number of characters (for example, the first 15 characters) of the message body may be utilized to generate the title of an outgoing email. Another modification to typical email programs may be replacing the technical term “email” with the more familiar English language word “mail” on the forms provided by the interface. All of these innovations may drastically reduce the learning curve for inexperienced computer users.

Annotation of content inside the email message may also be extended to the end of a message, where photo attachments may be embedded again at a larger thumbnail size with assistive text and buttons again. The plain English description “End of Message” may also be appended to the end of every message to clearly indicate to the reader that the email has ended. When a new message has been received a red description advising that “This is a new message” may be shown in the upper right hand corner of the document. When a user responds to a message, a blue description advising that “You replied on ‘X’” (where ‘X’ is the date of the reply) may be shown in the upper right hand corner of the document. All of these annotations may use plain English language, rather than technical terminology, to convey important email client functionality to the user.

It should be understood that use of particular colors, shapes, sizes, and textual descriptions in the foregoing discussion are for illustrative purposes only, and that there are numerous other combinations thereof that are comprehended by the present invention.

### Remote Management

The present invention, in one aspect thereof, provides online means for remote management by the Enabling Intermediary. This feature empowers the Enabling Intermediary to assist the Central Figure without having to physically be at the Central Figure's computer. Instead the program configuration settings, such as volume, program complexity (such as font size, cursor size, keyboard enablement including specifying keystrokes to ignore) and number of features (such as enabling boot-loading, enabling computer shutdown on program exit, address book management, bookmark management, whitelisting and blacklisting as described below) may all be configured online at the service provider website by the Enabling Intermediary. Additionally, the Enabling Intermediary can add, delete, re-order the list of members in the Central Figure's Contact Group as well as change their names, facial photos and emails. The Enabling Intermediary also has full reign to perform the following actions on the Central Figure's internet portal as well: altering their web bookmarks, favorite directory websites (such as medical news, weather station, radio and local newspaper) as well as other functions (such as selecting which games to make available, difficulty of games, advanced email features, urgent request feature as described below, etc.).

### Navigation Methodology

Navigation may be greatly simplified by the use of the button as a primary interface element. As previously described, the button may be presented in different sizes but with a similar shape and look-and-feel to enable the user to become familiar and comfortable with the interface. In an advantageous aspect of the present invention, all aspects of the program may be accessed by clicking through a series of buttons with plain English language descriptions. This is a great simplification from conventional interfaces which have several user interface elements to choose from (hyperlinks, submenus, selection forms, context menus, and so on).

The navigation system is specially designed for use by a computer novice. As described above, standard scrolling protocols may be removed from the interface as much as possible, as they are an extra abstraction and complication in the navigation process. Instead all static preconfigured content may be presented in a single screen and content may be limited to only essential features in order to keep screen content minimized and readable.

Screen transitions are typically confusing and disorienting for novice computer users, as these animations require good visual attentiveness and an eye for detailed changes in the forms. Screen transitions in the present invention may be kept to a minimum and made as consistent as possible. For this reason menus, sub-menu overlays or other fancy conventional navigation choices may be omitted.

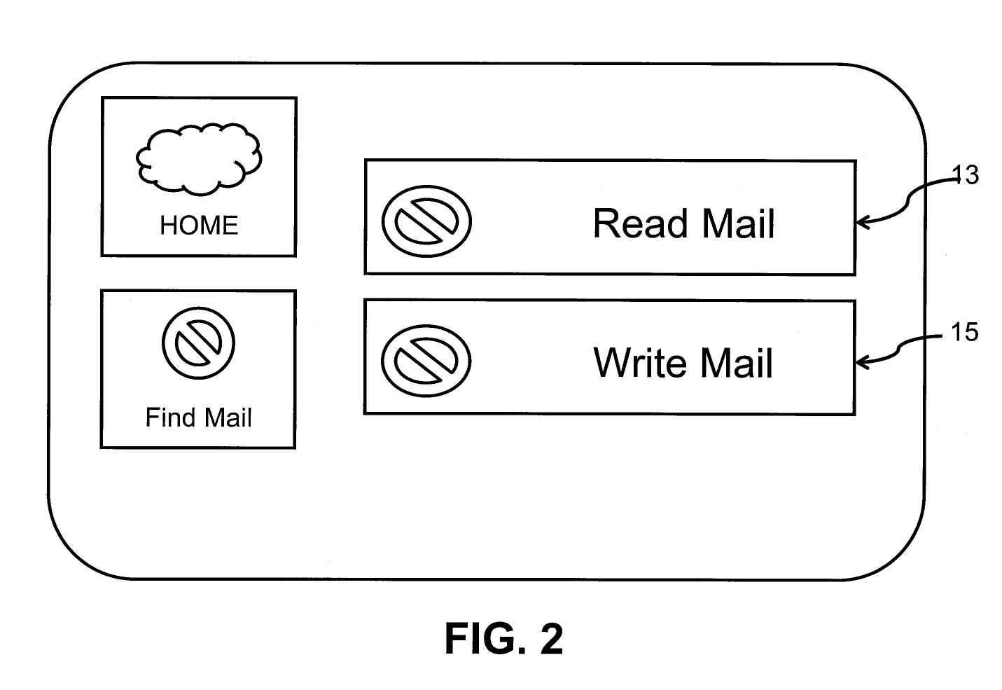

In one aspect of the present invention, a simplified, consistent navigation means is provided using the shell image and home button in the upper left hand corner of every form outside of the homepage (see for example FIG. 2 to FIG. 7). This consistency and association can be critical to helping novice users learn and feel comfortable navigating their way back to a known part of the program (the home or starting page).

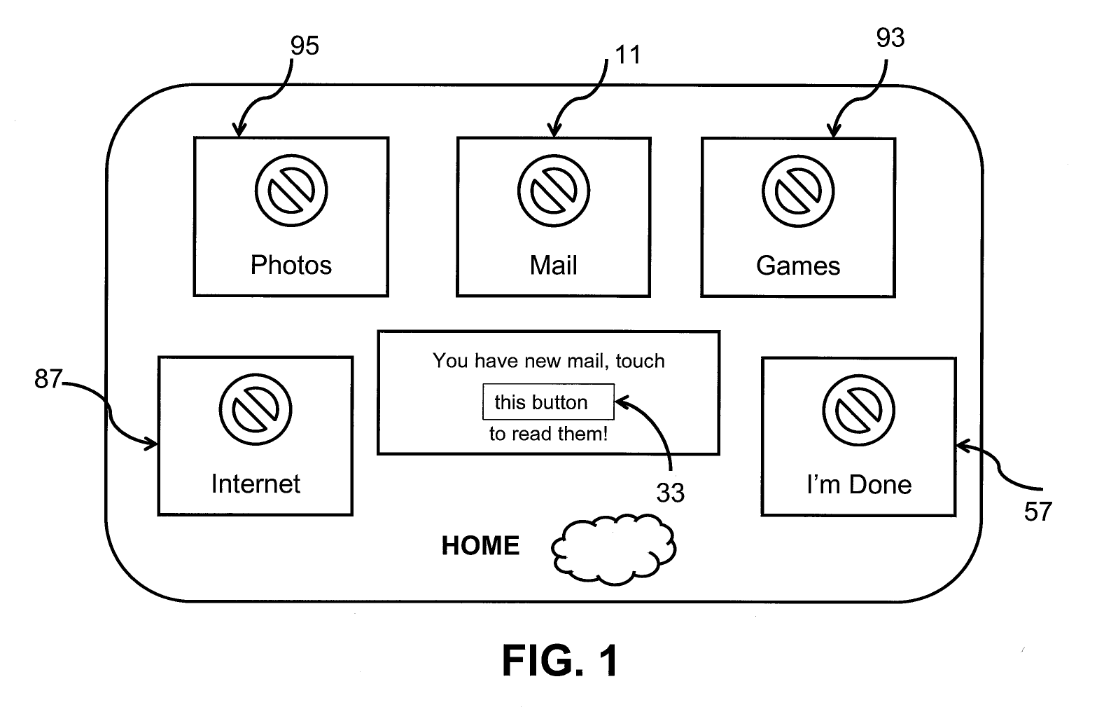

In another aspect of the present invention, a simplified navigation means is provided using email. FIG. 1 illustrates the homepage of the present invention, in one aspect thereof. The homepage may present the user with five clear options. If they want to read mail they click Mail 11 and then enter the mail selection screen.

FIG. 2 illustrates the mail selection screen of the present invention, in one aspect thereof. The mail selection screen may present the user with two fundamental choices, Read Mail 13 or Write Mail 15. Read Mail 13 may be the most common use case so it may be presented first, or above Write Mail 15. Read Mail 13 can be selected to enter the simplified email viewer. Write Mail 15 can be selected when the user wants to compose a new message. It may take two clicks for the user to get to reading their mail and three clicks for them to write to a person in their address book, thus minimizing the number of screens the user must navigate through while presenting all the content in a logical and in plain language.

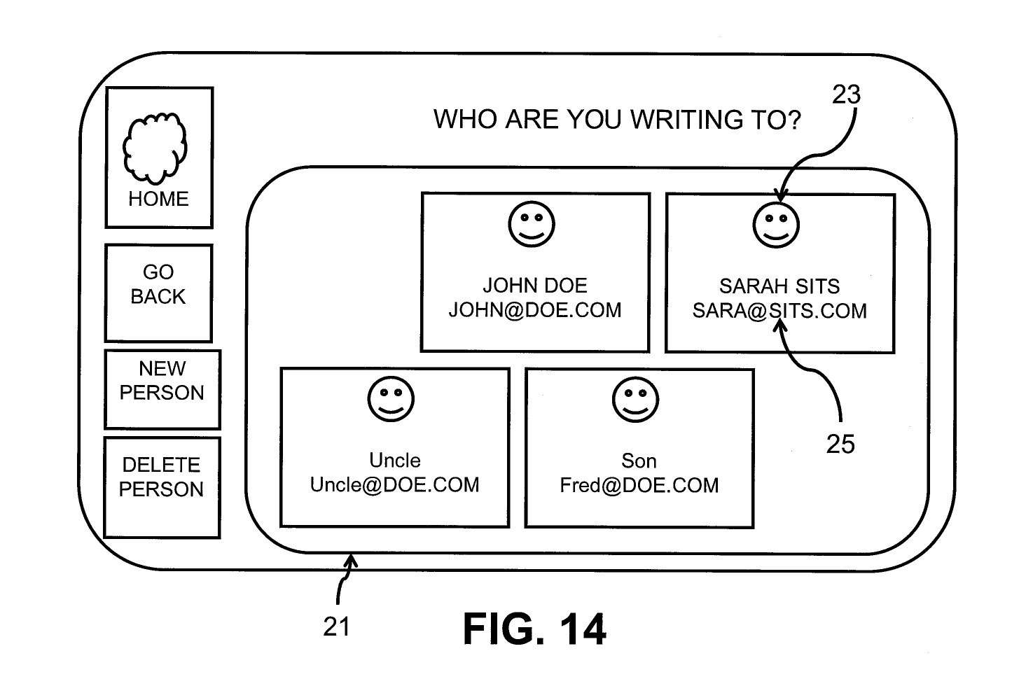

Navigation assistance may also be provided in certain circumstances. For example, if the user is confused and starts typing at a screen that does not require keystroke input (such as the mail selection screen illustrated in FIG. 2), the system may automatically take them to the next logical screen that accommodates keystroke input (in this case, the address book selection screen illustrated in FIG. 14 may be provided). Alternately, if the user starts typing at a screen not requiring keystroke input (such as the address book selection screen illustrated in FIG. 14) the system may aurally prompt them to stop and first select an available function (such as selecting the person they are writing to first).

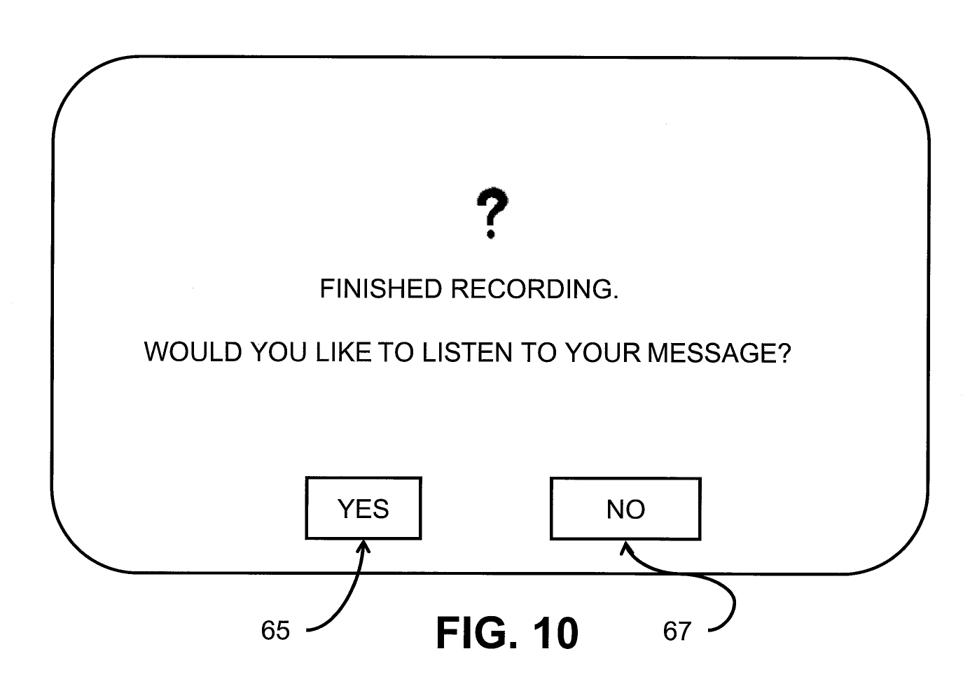

In a further aspect of the present invention, a technique for navigation simplification is provided when a decision needs to be made in the control flow of the application. Instead of displaying a dialog box or form within the application, the program may take over the full screen with a large written and optionally aural prompt, along with binary “Yes” or “No” response buttons (such as that illustrated in FIG. 10). Handholding the user through all decision making steps may ensure that the process is far less confusing, as there are only two possible buttons they could press. All prompts in the system may be operable to phrase the question such that a clear “Yes” or “No” button response is appropriate. Similarly, all informational prompts in the system may present a single OK button confirmation response.

This process may ensure that only one decision is being made at a time. Older or cognitively impaired thinkers may have trouble multi-tasking, and thinking linearly is typically much simpler, especially when learning something new. Moreover, conventional decision making tasks are embedded within other windows or presented in a dialog box on top of other forms. This requires additional spatial awareness that is another unnecessary computer abstraction.

FIG. 3 illustrates an email document reader of the present invention, in one aspect thereof. Another simplification in the navigation process may be the inclusion of redundant elements at point of potential confusion. While the email document reader may have clearly demarcated “Next Email” 17 and “Reply” 19 buttons, inexperienced computer users may not visually search for these functions. Instead they may read in a linear fashion from the start of the message to the end. Hence, redundant copies of these buttons may also be embedded at the end of every email message with plain English sentences describing them. These sentences may allow the user to read the message from start to end and make the next action all while following their email in a completely visually linear fashion.

### Communication Utilities

FIG. 14 illustrates a visual address book of the present invention, in one aspect thereof. The present invention, in one aspect thereof, is directed to reducing the complexity involved in writing an email message. For example, a visual address book 21 and whitelist system may be used to reduce complexity for a user and to provide additional security against unsolicited mail. The user may choose to write an email by touching (or clicking) a photo of the face 23 of the person 25 they want to message instead of having to enter their name or email address. An address book 21 of photos may be entered at a central website administered by a system administrator, such as the software vendor and service provider, by members of the Contact Group. Only members who are part of the Contact Group may be able to message the user. Individuals may only join the Contact Group if they are given approval from the Enabling Intermediary who configured the application for the user. This whitelist system prevents unwanted mail from reaching the user. The user can also instruct the Enabling Intermediary to blacklist particular contacts as well. This approach to email writing provides a substantially more intuitive interface for the Central Figure, who may not be familiar with email addresses, and empowers the Enabling Intermediary, who can manage the Central Figure's visual address book online.

As one significant advantage, the methods and system of the present invention may be provided as a computer program that is adapted and arranged to render screen displays to be visually scalable, and thus to scale to the appropriate or desired resolution and screen size of the monitor used by the Central Figure. The computer program, in one aspect thereof, may be adapted and arranged also to provide a widescreen format, thus allowing more content to be displayed, while the two-dimensional scaling afforded by the software may maintain relative sizes and proportions, and thus makes the various control buttons scalably larger. These features are quite advantageous and very useful for users having impaired vision or difficulty in touching a smaller onscreen target;

As yet another advantage, the computer program, in one aspect thereof, may be adapted and arranged to provide voice communications in a form or forms that preserve the original meanings and language of those voice communications. Thus, instead of converting voice communications to text or other non-voice formats, the systems and the computer program of the invention preserve the original sound file and forward it, for example, as a compressed MP3 format. By doing so, the invention may enable use of the system by seniors or others who cannot type or who speak languages other than those offered by voice-to-text systems.

In a similar positive aspect, the computer program, in one aspect thereof, may be adapted and arranged to provide basic voice recognition capabilities to thereby allow easy access to basic communication features of the invention, such as email, photos, games, the internet and shut down functions. In one form of these novel features, the text on the buttons shown in the display screen also respond visually when these commands are spoken by the Central Figure or other user.

The computer program, in another aspect thereof, may also be adapted and arranged to provide priority over desktop functions of the Central Figure's computer. Thus, a client application may be configured to take over an entire computer desktop in order to create an immersive and user friendly experience directly from bootup. This may be especially advantageous to users who exclusively run the computer program and systems provided in accordance with the present invention.

In a related aspect of the present invention, for a user exclusively running the computer program and systems provided in accordance with the present invention, the computer program may be adapted and arranged to include a monitoring program that monitors the activity of the computer program and causes a restart when it stops, or triggers a system restart if re-launching the computer program fails. Related features may include remote email system administration in the event that all attempts to restart the computer program fail.

The computer program, as described above, may also be operable to run over the desktop applications of the Central Figure's computer. Thus, if the computer program is provided as an application running on the client computer, rather than as web-based, it may be managed without necessarily going through a website or other Internet-based site.

In another aspect of the computer program, another version may run in homes having computers shared by a plurality of diverse people. This includes, for example, where children share a computer with a senior Central Figure, such as an elderly relative. The present systems and methods therefore encompass adaptations, methods and arrangements whereby the computer used by a plurality of people can easily switch between the computer program and the OS. The computer program therefore provides for this circumstance, adaptations, methods and arrangements manifesting as a launcher application. To further facilitate ease of use, the launcher application may appear as a relatively large button on the graphical user desktop of the OS to allow vision impaired or mobility impaired users to launch the program. The button may be designed to intelligently appear when no other programs are actively running so as not to annoy other (expert) computer users using the computer.

Thus, the computer program of the present invention may be adapted and arranged such that the user has to know only the concept of a button, and that touching (or clicking) a button triggers the operation of the stated function. These simplified computer interfaces reduce abstractions, while also stripping away many of the features of modern computers that make them insecure. With the present invention, certain file attachments may be automatically ignored. Thus, a user's computer cannot get viruses from circulating files that are of the ignored file types, which may optionally include ZIP files or EXE files. File downloads and installation of spyware/malware or viruses may also be prevented because the computer program of the present invention uses its own locked down internet browser.

In yet another aspect of the present invention, the computer program, systems, methods, adaptations and arrangements of the invention include business models whereby certain types of focused sponsorships can be provided to the people using the computer program and systems. For example, sponsors can purchase placement on a front page of the internet website operated by the software vendor/service provider of the system and/or on the homepage portal of the computer program, whether provided on a client computer or as a web-based application. Such sponsors might include, as examples, those selling medical equipment, health insurance, retirement home services or hospice care.

As another example, a sponsor such as a retail photo printing store could be integrated into the photo viewer of the present invention to allow users to easily print a photo by emailing it to the sponsor and arranging for that sponsor to return the printed photo by conventional mail.

Services from sponsors such as internet phone service companies (for example, those providing Voice Over IP) could be integrated into the email client to allow users to contact another user via telephone instead of just texting them or leaving a voicemail. This feature could provide revenue to both the sponsor and the secondary revenue recipient, such as on a revenue sharing basis between the sponsor and software vendor/service provider, between the sponsor and a charity, or between a sponsor and a retirement home or hospice running multiple copies of the computer program. Moreover, sponsored splash advertisements or video advertisements could be integrated into the Games function to display a short advertisement prior to starting each game.

### Urgent Request Feature

In accordance with other advantageous aspects of the invention, an Urgent Request Feature (“URF”) may be configured by, for example, the Enabling Intermediary to provide an easy way for the Central Figure to communicate to certain people in or outside of his or her Contact Group list that an “urgent circumstance” exists. In one aspect of the URF, an emergency telephone call may be automatically sent (such as dialing 911 and providing a prerecorded message to emergency authorities) to seek help during a health crisis or fire emergency. In another aspect of the URF, the Central Figure may alert persons in the Contact Group of non-emergency needs such as the need to go grocery shopping, the need to be transported to a scheduled doctor visit, or the urgent need for social communication.

In one aspect of the URF, the function may be facilitated by a button displayed by the computer program. The button may be captioned by “Help!” or a like message, and displayed on the homepage or optionally on every page presented by the interface. Where the button is displayed on the homepage, the user may still never be more than two button presses away from the button (since a “Home” button may be displayed on every other page). In some configurations, the help may be configured so that, when the user presses the button, several high priority emails are sent out to everyone on an “Urgency Contact List”. Simultaneously, the system may attempt to call “Emergency Contact A”, “Emergency Contact B”, etc., until all contacts have been tried.

If no contacts can be reached within a pre-set time, the system may contact the software vendor/service provider to request the assistance of one of the provider's phone support staff to gain the assistance needed. In other advantageous aspects of this feature, the software may provide the Enabling Intermediary with the ability to set up a list of “Urgency Contacts” including, for example, phone numbers and email addresses for the purposes described above.

Extensions of the computer program of the present invention may include a login protocol for multi-user instances. The login protocol may include an alphabetical login based, for example, on the user's last name. The password on the user's account may be configurable and may include the user's birth month, year, institutional room number or home address or a more conventional alphanumeric password. Conventional passwords can be difficult for many users to remember, but even in the later stages of dementia in nursing homes, the majority of users will remember their name and birth date, making this particular password an ideal choice for improving the user's functional autonomy.

Multi-user instances of the invention may also require synchronization between several client workstations that may be installed at, for example, a retirement home, nursing home or senior community center. In this aspect of the present invention, all changes such as reading, responding to and/or deleting a message on one workstation are propagated to the server and then back to all the other clients running the system. This may be accomplished through state information sent as messages in the user's email account.

### Implementation in One Aspect of the Present Invention

The following example, in conjunction with FIG. 1 to FIG. 23, and in conjunction with the foregoing features and navigational steps, illustrates some aspects of the present invention as described above. Numerous other examples, configurations, capabilities and advantages are within the scope and spirit of the invention. The example may best be understood having reference to an elderly Central Figure, unfamiliar with use of his or her computer, with adult children, X and Y.

Independently of the system of the present invention, X may navigate to a website offering at least one aspect of the computer program of the present invention, and may purchase or license the computer program on behalf of Central Figure, in order to provide Central Figure with an additional and simplified means of communicating with his or her family and friends. Via the internet, X may enroll (“sign up”) for the services facilitated by the computer program.

As part of the enrollment process, through his or her home or work computer, X may download the computer program and also create a password and account for himself or herself as the Enabling Intermediary on the service provider website. The password may be referred to as the Supervisory Password.

In accordance with the system of the present invention, X may also set up a “Central Password” to be provided to Central Figure's friends and relatives. Everyone with the Central Password can sign up to be a member of Central Figure's “Contact Group.” Thus enabled with the Central Password, anyone in the Contact Group can send email messages to Central Figure. X may communicate the Central Password to Central Figure's friends and relatives using any method (i.e. the present invention does not require its use for communicating the password) to convey to them that they can use the system to communicate with Central Figure. As part of the enrollment process, X may also receive a new email account created for Central Figure, for example: cf@domain.com.

X may then install the downloaded computer program onto Central Figure's PC. Central Figure may typically be confused by the numerous choices offered by the native operating system of his or her computer and, because of this, X may utilize the configuration tools of the computer program to automatically set Central Figure's computer to load the computer program immediately upon the operating system bootup, and/or to go into hibernate mode when Central Figure touches the Shut Down button of the computer program. Thus configured, Central Figure need never interact with the operating system's own interface unless he or she affirmatively chooses to do so.

Alternatively, as part of the enrollment process, the service provider may provide X with the address of a secure website to be used as the web-based interface to the computer program of the present invention, which X may then communicate to the Central Figure.

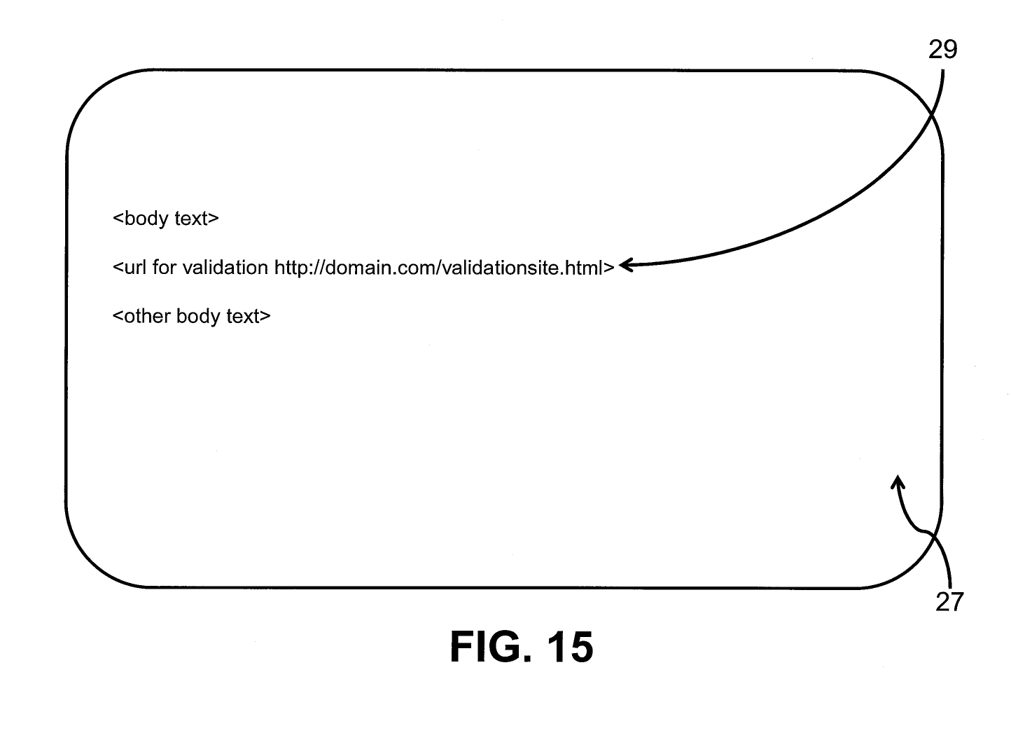

FIG. 15 illustrates a whitelist mail response of the present invention, in one aspect thereof. Assuming, for example, that X communicated the Central Password to Y, Y may receive X's message. Y may therefore use his or her email client (which can be any client, not necessarily being associated with the present invention) and may compose an email message to Central Figure. Assuming that Y has not already authenticated with the system of the present invention, the computer program client running on Central Figure's computer may download Y's email but identify that Y is not on the whitelist. The computer program client may then automatically reply by automatically generating an email 27 to Y with a message that Y's email cannot be accepted. Y then must then follow the URL 29 provided in this email to validate Y to the service provider website.

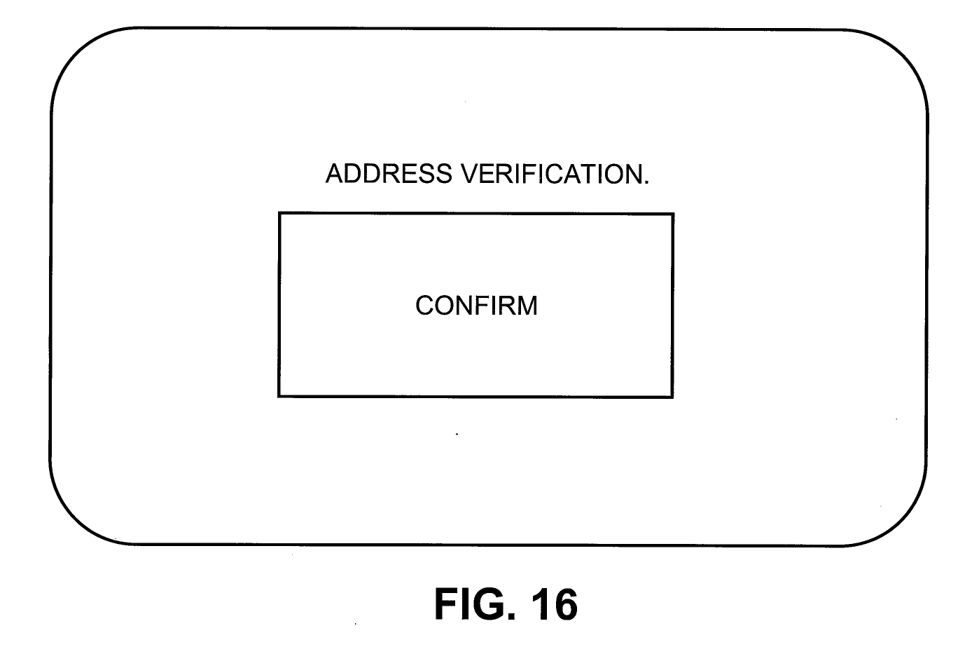

FIG. 16 illustrates a validation website provided by the service provider in accordance with the present invention, in one aspect thereof. At the validation website, Y may be required to enter the “Central Password” to gain entry to the “Contact group.”

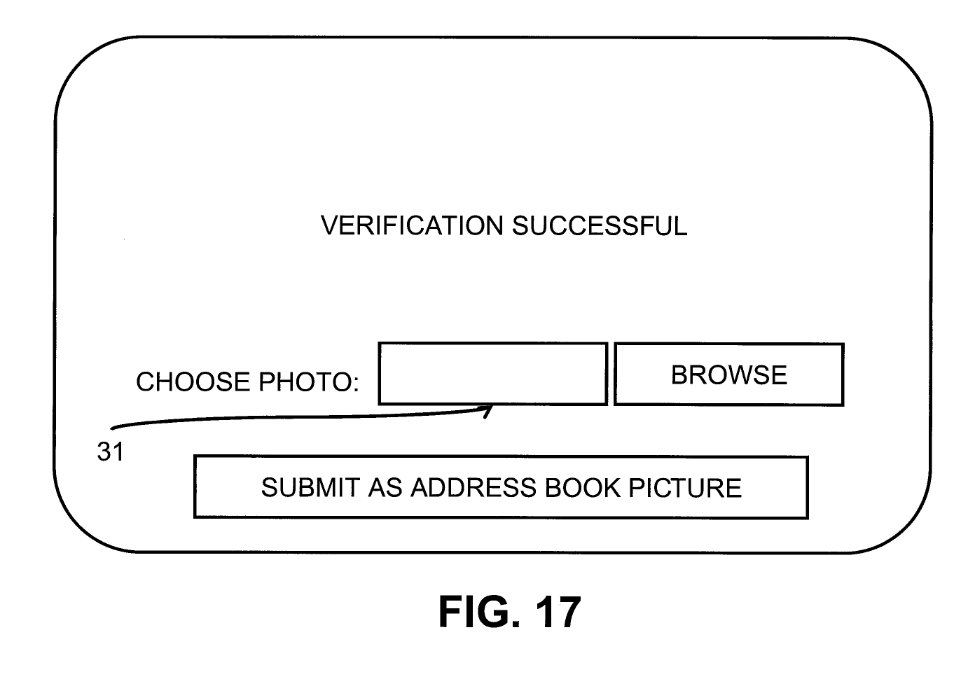

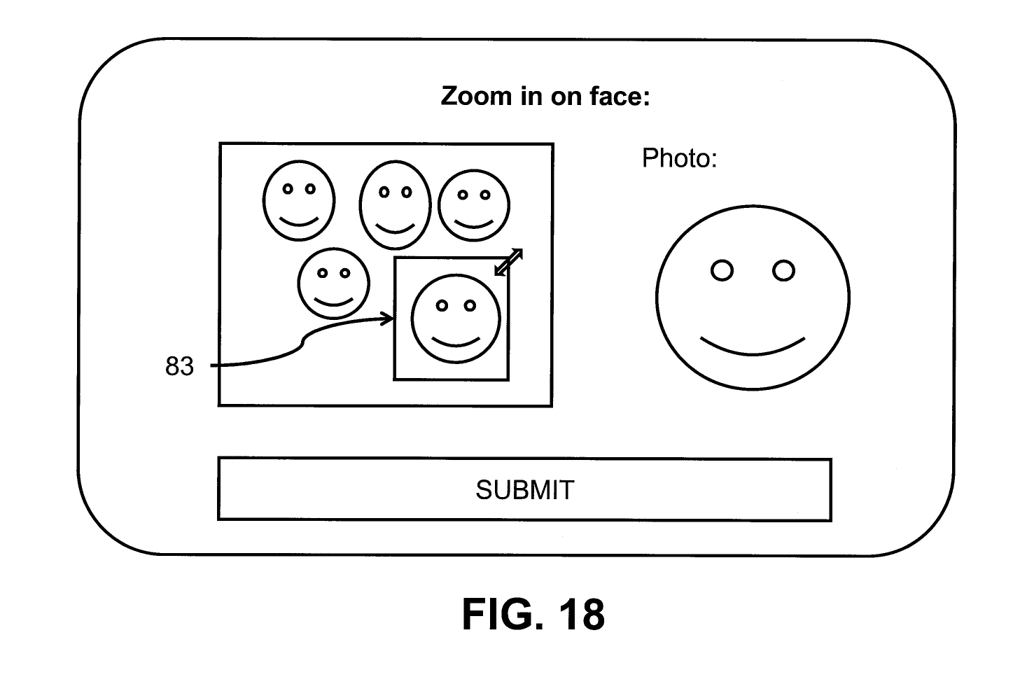

FIG. 17 illustrates a validation confirmation website in accordance with the present invention, in one aspect thereof. Once Y executes the required validation steps, Y may be presented with the validation message and be given an opportunity to upload a photo 31 of himself or herself. FIG. 18 illustrates a photo selection tool in accordance with the present invention, in one aspect thereof. Optionally, the validation website can provide a means to crop 83 the new contact's picture from a larger digital photo, or use other means of selecting a photo.

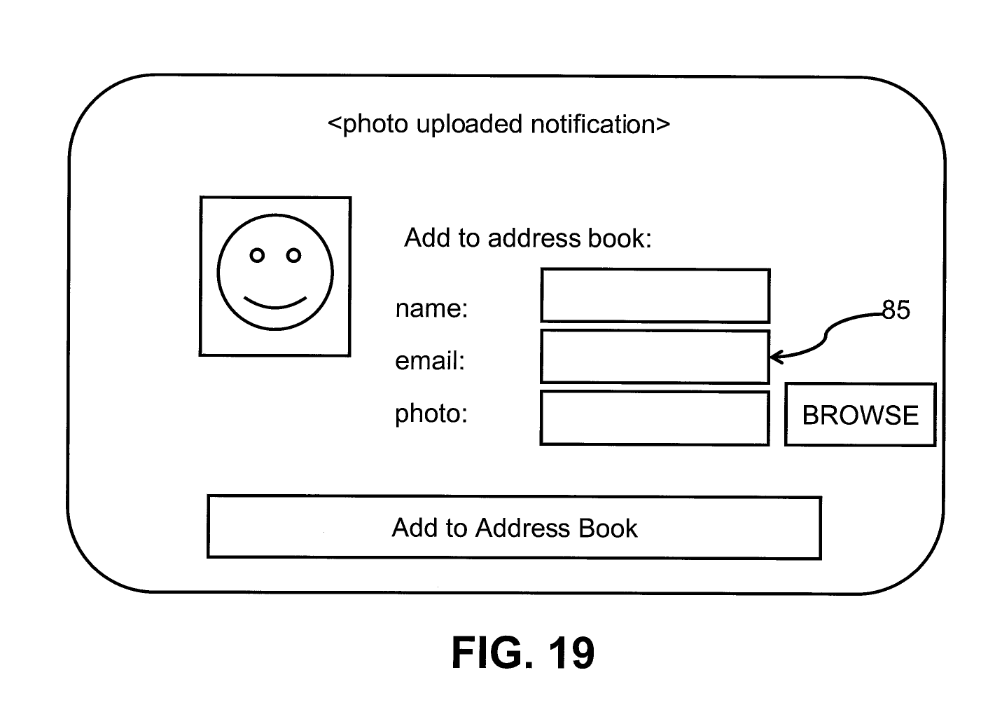

FIG. 19 illustrates a means for introducing the system of the present invention to further persons, in accordance with the present invention, in one aspect thereof. Once Y has uploaded a photo, they may be provided with a means of disseminating information about the Central Figure's Contact Group to another internet user, by providing a contact email address 85 for the other internet user along with, optionally, the other internet user's name. The system may generate an automatic email sent to the other internet user inviting them to join the Contact Group through validation.

Assuming a group of contacts has been added to the Contact Group, Central Figure may decide that he or she wishes to use the computer program to communicate with his or her family and friends in the Contact Group. Central Figure may therefore turn on his or her computer, which may boot into the computer program automatically, if configured to do so, or present the Central Figure with means to launch the computer program. The computer program may display a welcome message and display the homepage, as illustrated in FIG. 1, to the Central Figure. In this example, Central Figure may see that he or she has two new messages so he or she touches “this button” 33 on the homepage, taking Central Figure directly to the simple email reader.

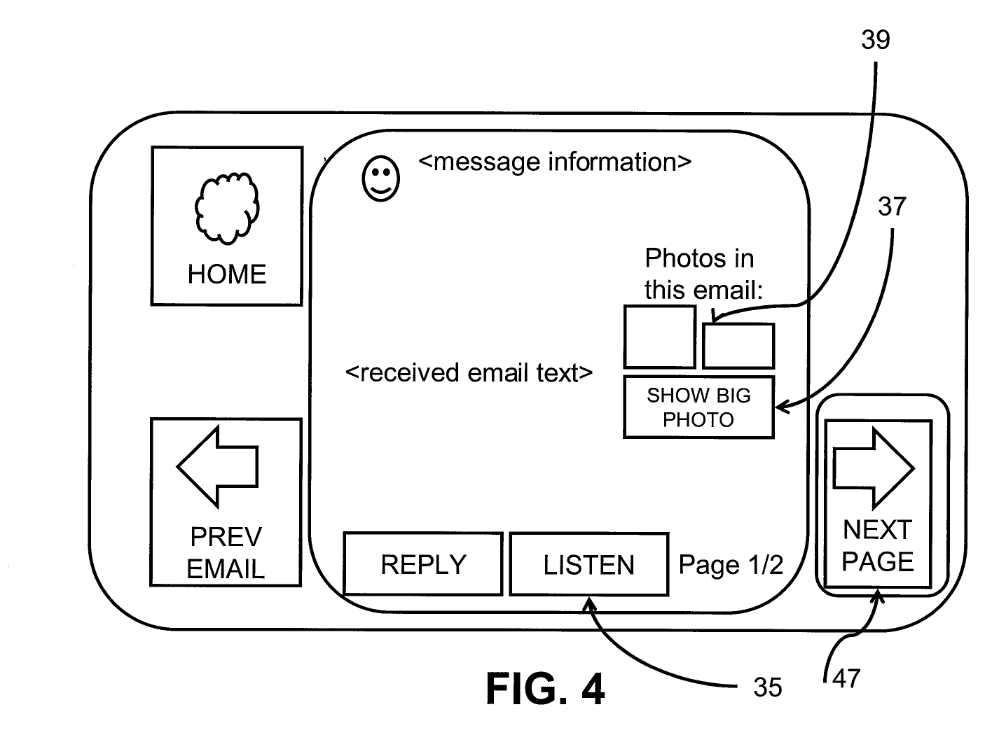

FIG. 4 illustrates an email reader of the present invention, in one aspect thereof, wherein an email contains attached photos. The computer program may be adapted and arranged to provide special formatting and related features for those with attenuated abilities, such as vision deficits, as described above. Due to an affliction such as macular degeneration, Central Figure may have trouble reading the screen, despite the high contrast and large fonts that the computer program provides. Central Figure may therefore touch the Listen button 35, for example. The Listen button 35 may enable the voice message function of the computer program, which may read the entire message from another relative Z to Central Figure exactly as Z left it, line by line, and page by page.

Central Figure may see on the computer screen that there are small photo representations 37, 39 included in Z's email. Central Figure therefore may touch one of the small photo representations 37, 39 on the screen and may be taken directly to the photo viewer.

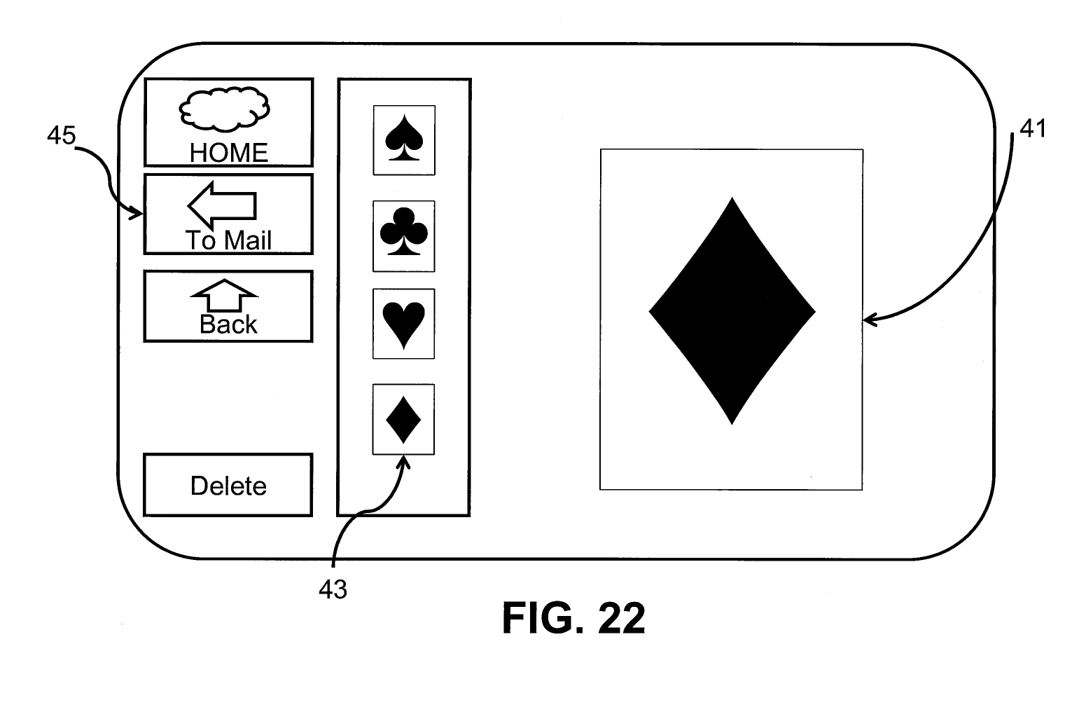

FIG. 22 illustrates a photo viewer of the present invention, in one aspect thereof. The photo browser may be launched by selecting the photo button 95 from the homepage as previously illustrated in FIG. 1 or by the actions taken above. Central Figure may have little experience with computers, therefore not knowing about files, folders and email attachments. Despite this lack of experience, through the photo viewer, Central Figure can see all the other photos 41 that Z sent just by touching the smaller version of that photo 43. Central Figure may also touch the “To Mail” button 45 to return to his or her email and finish reading the message from Z by touching the “Next Page” 47 button until Central Figure reaches the next e-mail.

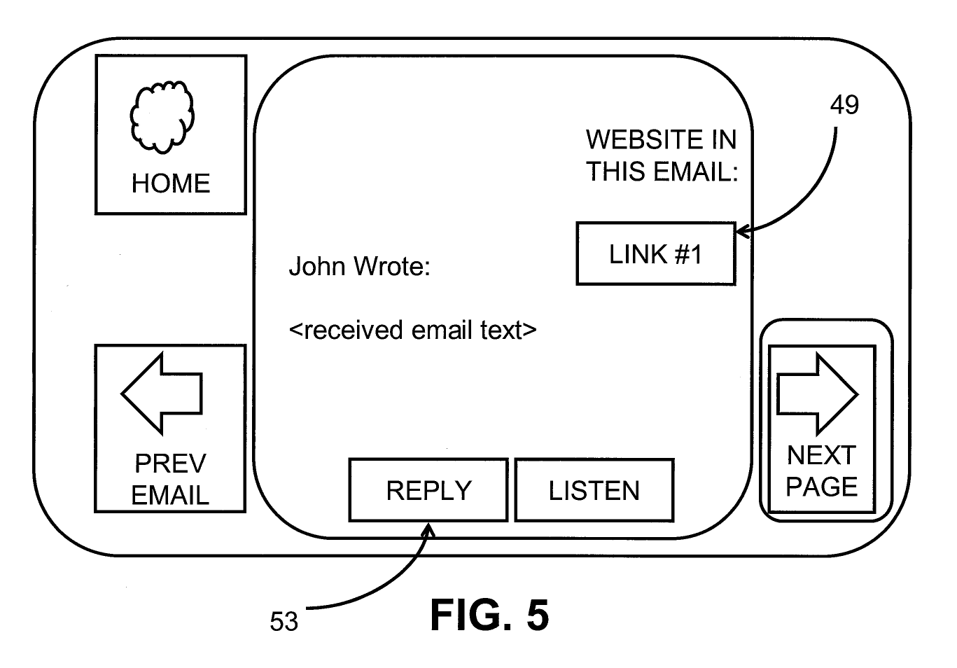

FIG. 5 illustrates an email reader of the present invention, in one aspect thereof, wherein an email contains an URL. The computer program may also simplify other computer-facilitated communications. For example, Central Figure may have never used the Internet. Nonetheless, Central Figure may see that there is a button in his or her email from X which says “Websites in this Email: Link # 1” 49. Central Figure may not know about URL'S, hyperlinks or internet browsers. However, Central Figure may know the concept of actuation via a button, so he or she may touch the button marked “Link # 1” 49. This button 49 may take Central Figure to the custom internet browser which may immediately connect Central Figure directly to the URL sent in the email from X.

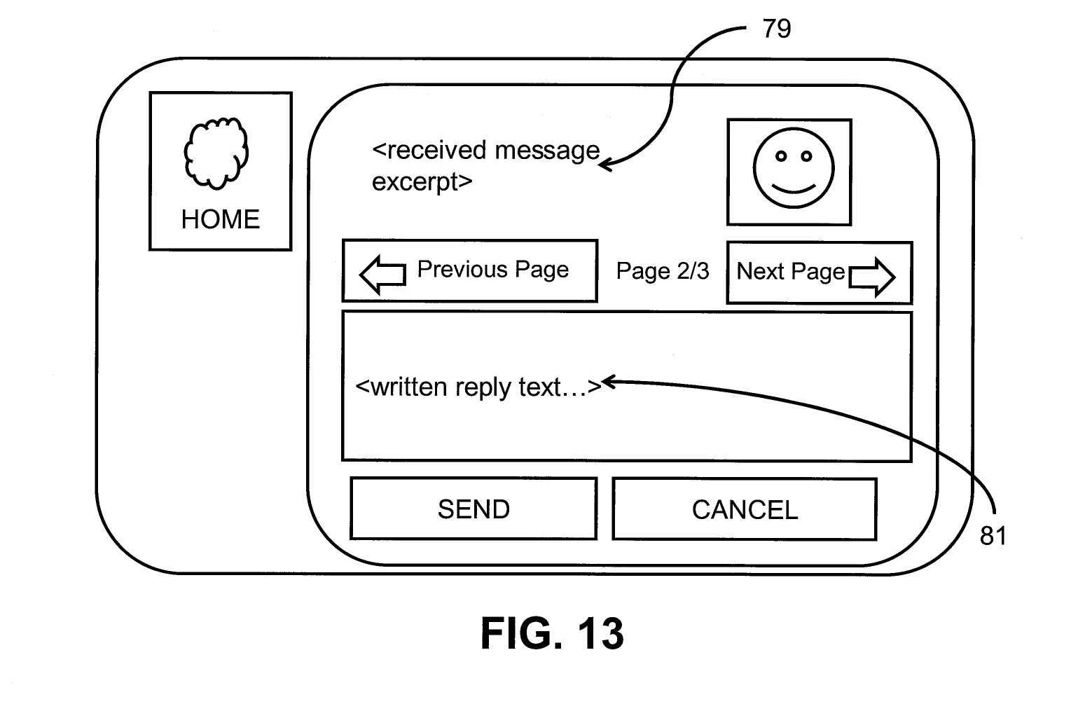

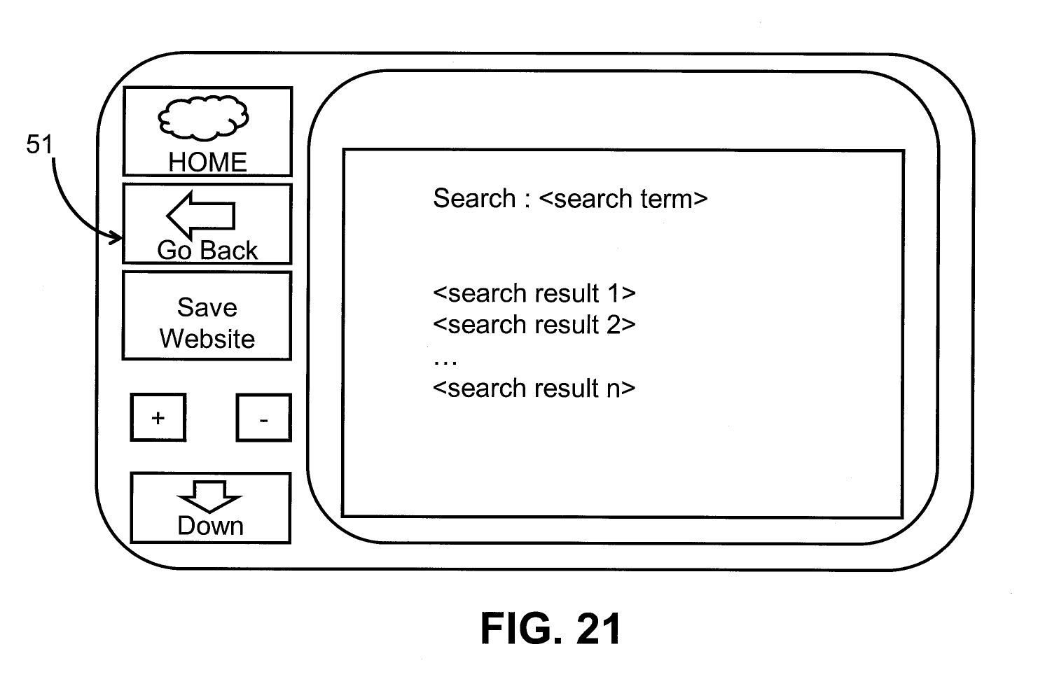

FIG. 21 illustrates an internet browser of the present invention, in one aspect thereof. Central Figure may browse the internet or may touch the “Go Back” button 51 on to return to the e-mail from X. Central Figure may decide to respond to the link sent by touching the “Reply” button 53. In accordance with some of the user-friendly redundancies of the system, Central Figure may then be asked (both visually by displayed words and verbally by an aural system prompt) whether he or she would like to type a message or send a voicemail. FIG. 13 illustrates an email writer of the present invention, in one aspect thereof, wherein a user is replying to a received message. If the Central Figure chooses to reply by text, a screen may be provided wherein the received message 79 is displayed on one part of the screen and the reply being written 81 is displayed on another part of the screen. This may enable the Central Figure to recollect the contents of the received email to which he or she is replying.

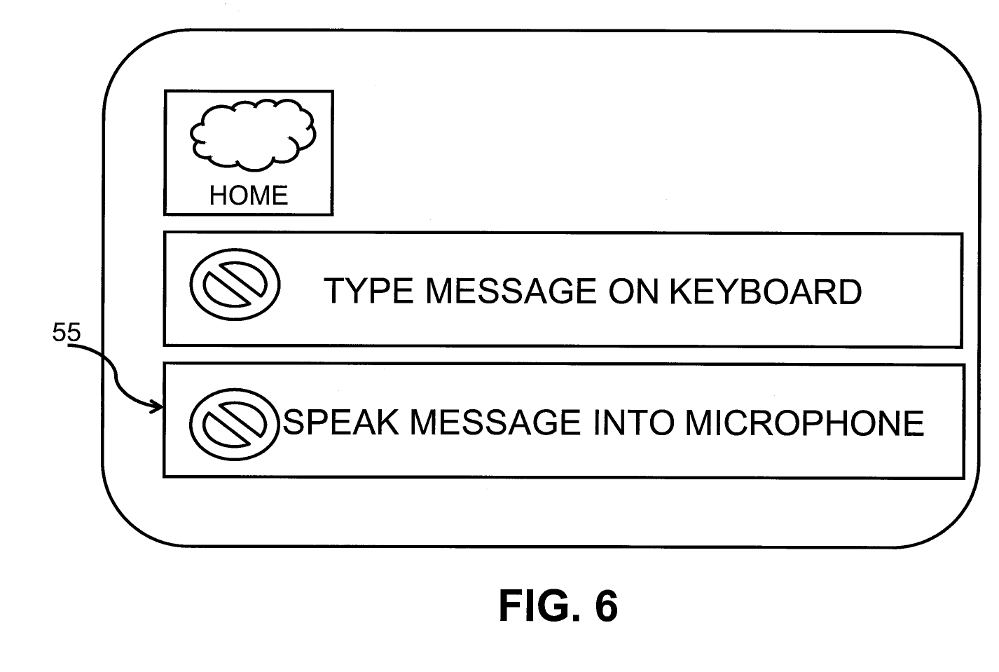

FIG. 6 illustrates a system prompt of the present invention, in one aspect thereof, wherein Central Figure has the option of sending an email by typed message or by voice. Optionally, the Central Figure could choose to initiate a video message, voice conversation, video conversation, or instant messaging conversation with a member of the Contact Group.

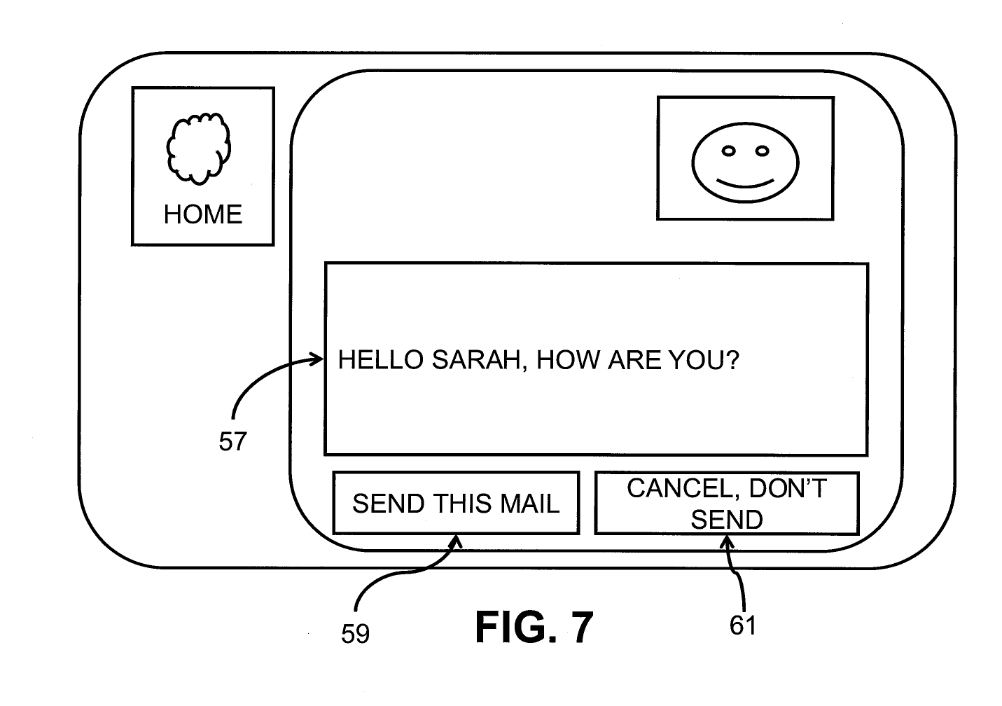

FIG. 7 illustrates an email writer of the present invention, in one aspect thereof. If the Central Figure chooses to type an email, the Central Figure may be presented with a means by which to enter the text the Central Figure wishes to send. The means may be a textbox 57 with clearly marked buttons for sending 59 or canceling 61 the message.

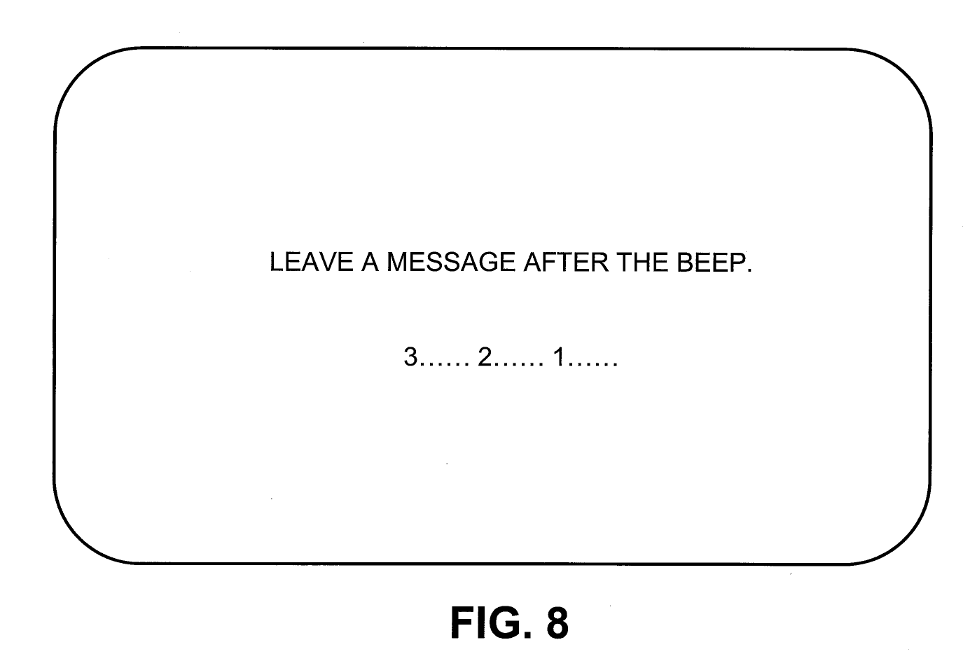

Central Figure may be uncomfortable with typing. In accordance with FIG. 6, as previously illustrated, the Central Figure may choose to send a voicemail reply to X and therefore touches the “Speak message into microphone” button 55 on the screen. FIG. 8 illustrates the computer program of the present invention, in one aspect thereof, wherein a user is prompted to record a voice message. If the Central Figure chose to send a voice message, the computer program may prompt the Central Figure with a countdown timer to prepare the Central Figure to speak into the microphone. By speaking into the microphone, Central Figure may record a voicemail, and be prompted to listen to the recording to review it for content, etc. After listening to the message, Central Figure may send it to X.

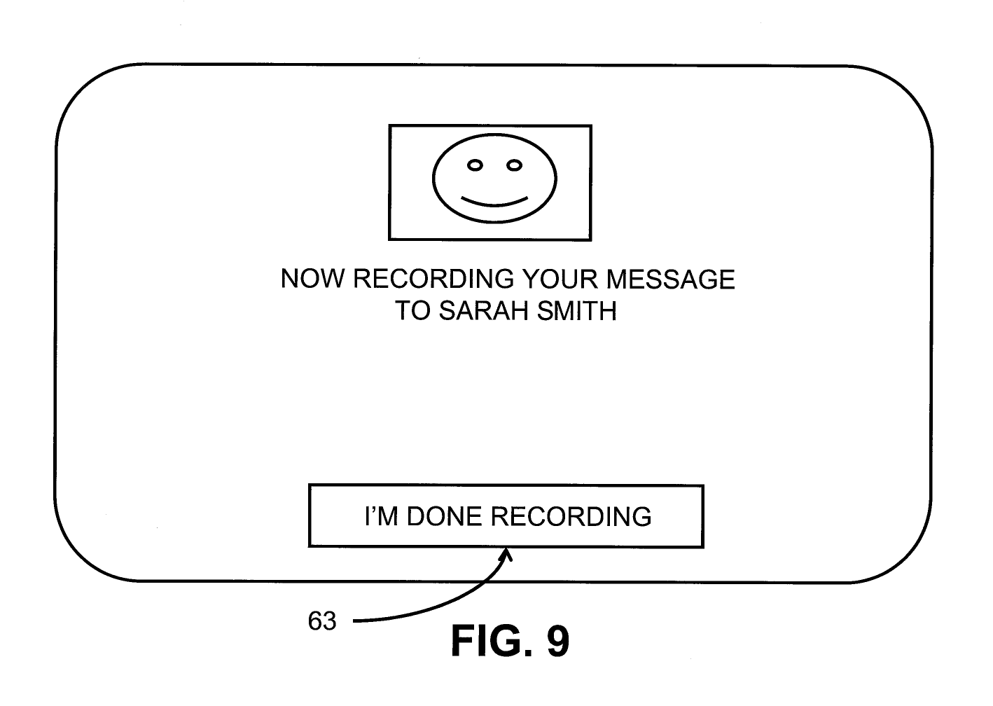

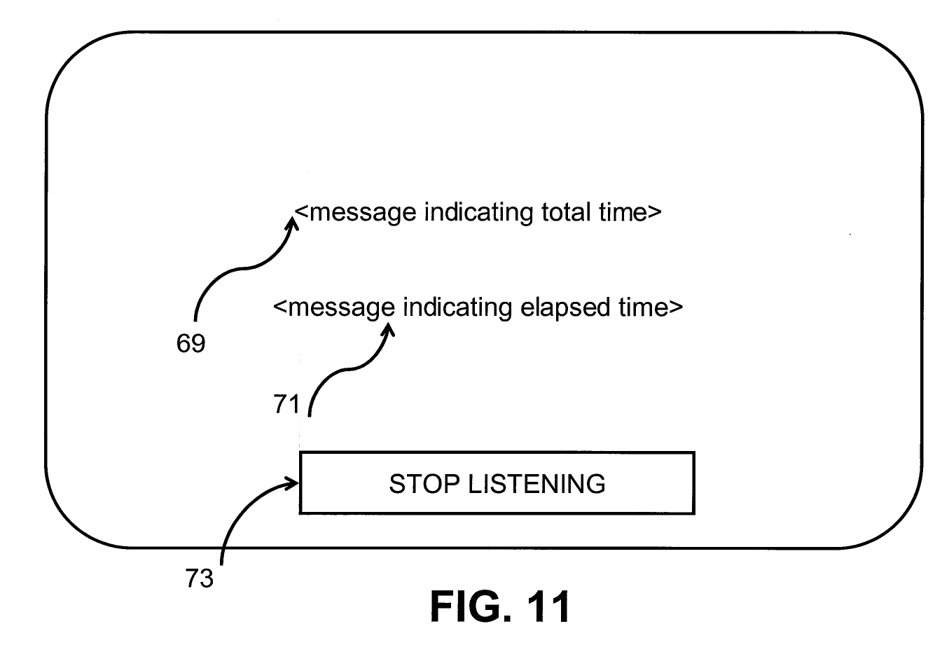

FIG. 9 illustrates the computer program of the present invention, in one aspect thereof, wherein a user is instructed that it is recording a voice message. Once the Central Figure begins to speak, the recording may continue until the Central Figure affirmatively terminates the recording, which can be accomplished by means of a button that may be labeled with a clear caption such as “I'm done recording” 63. When the Central Figure touches the button, he or she may be presented with a screen allowing the Central Figure to listen to the recording prior to sending the message. FIG. 10 illustrates the computer program of the present invention, in one aspect thereof, wherein a user is instructed that it has completed recording a voice message. The user may be given the simple options of “Yes” 65 or “No” 67 to indicate their choice of whether to listen to the message they have recorded. FIG. 11 illustrates the computer program of the present invention, in one aspect thereof, wherein the system is operable to play back a recorded voice message. If the Central Figure chose to listen to the message, they may be presented with a screen that displays the total time 69 as well as elapsed duration 71 of the message. There may also be a button provided to stop playback of the message, which may be provided with a clear caption such as “Stop Listening” 73.

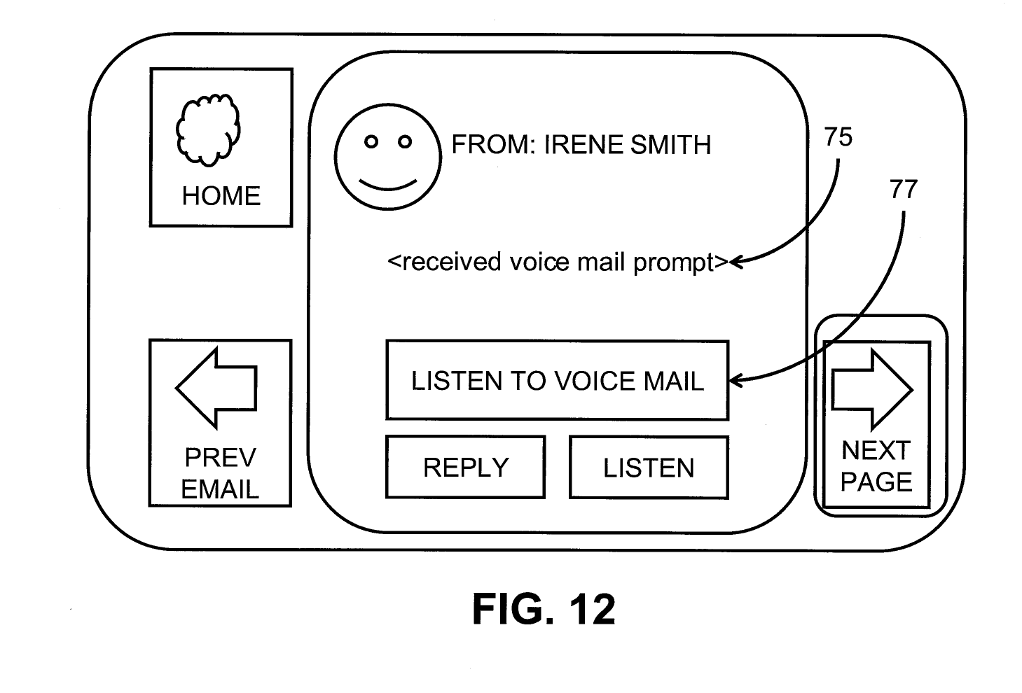

Similarly, voice messages may be received by the Central Figure from other persons in the Central Figure's Contact Group. FIG. 12 illustrates an email reader of the present invention, in one aspect thereof, wherein a user may listen to a received voice message. If a voice message is received, it may be presented to the Central Figure similarly to other email messages, as described above. If the Central Figure selects the message, the screen may be used to present the Central Figure with an instructional message 75 that a voice message is received, and a large button with a caption such as “Listen to Voice Mail” 77. Selecting such a button may enable the computer program to play back the voice message.

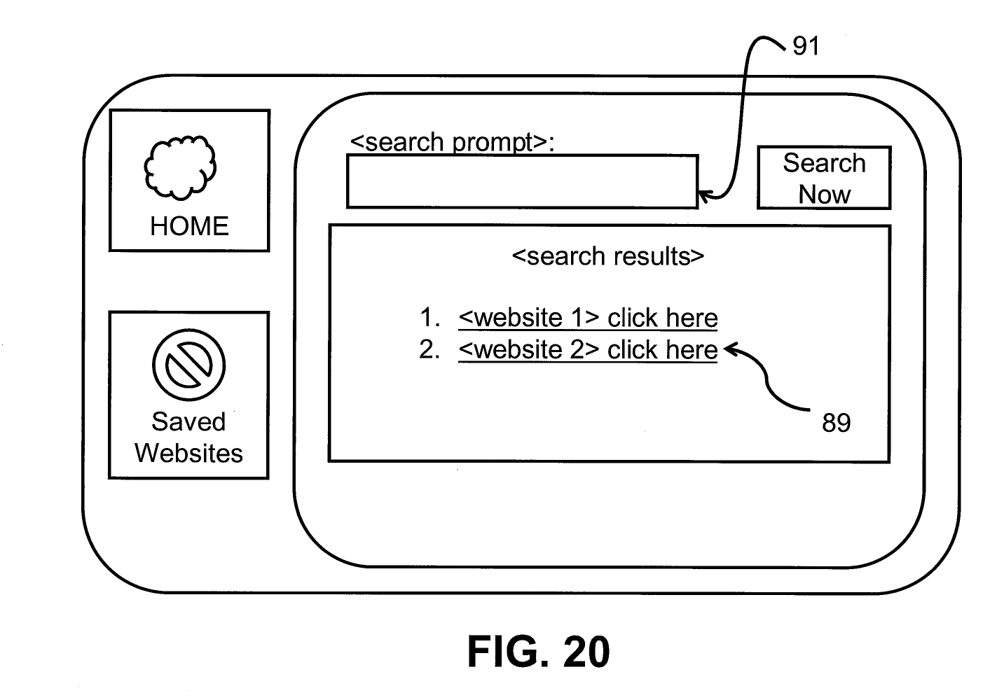

FIG. 20 illustrates an internet portal in accordance with the present invention, in one aspect thereof. From the homepage, as illustrated in FIG. 1, the Central Figure may wish to browse the Internet, and can launch an internet portal by touching the Internet button 87. The internet portal may display the list of the Central Figure's bookmarks 89 and may provide a means for the Central Figure to search 91 for other websites on the internet. Using the search feature may result in a screen being displayed in accordance with FIG. 21, as illustrated above, except that touching the “Go Back” button may enable the Central Figure to return to the previous viewed screen rather than an email message with an embedded URL.

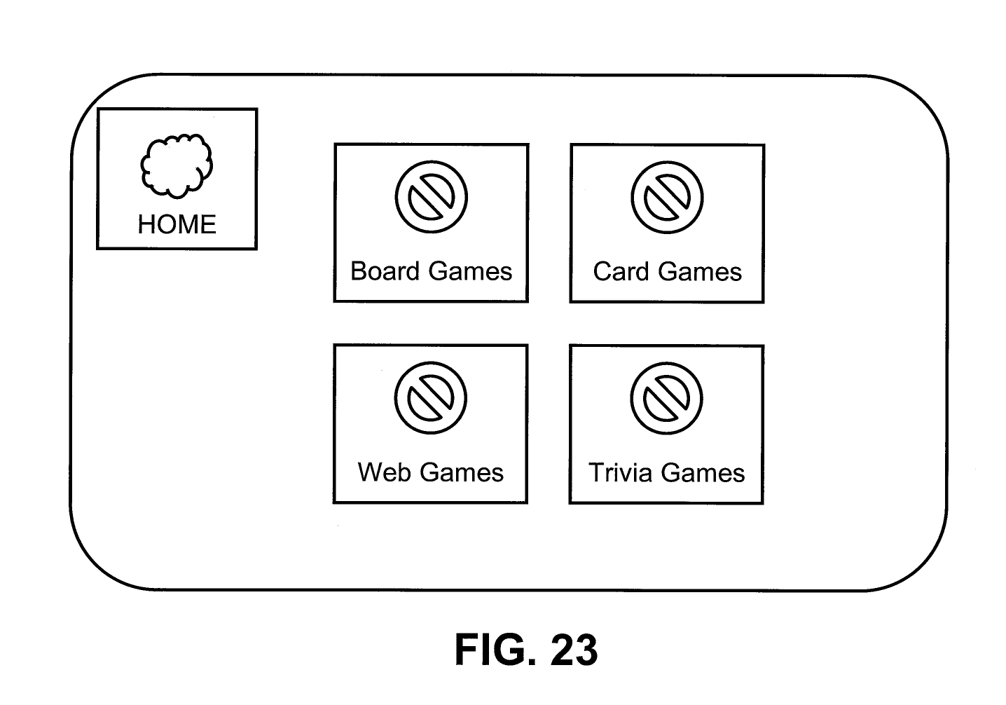

Additionally, the Central Figure may launch a games interface by selecting the Games button 93 from the homepage previously illustrated in FIG. 1. Touching the button may cause the computer program to launch a games interface wherein a selection of games may be made available to the Central Figure, depending on the configuration chosen by the Enabling Intermediary, as described above. FIG. 23 illustrates a games interface of the present invention, in one aspect thereof.

In accordance with the advantageous simplified functions of the computer program, it may be configured for easy shut down by the Central Figure. In accordance with the example described herein, X configured Central Figure's computer to hibernate upon shutdown of the computer program. Thus, when Central Figure is done using the computer, he or she may simply touch the Home button, which may be enabled to always appears in the upper left hand corner (or other consistent location) as an anchor connecting back to the Home page. Central Figure may then touch the Shut Down button. The touched Shut Down button then hibernates the computer to save power, in accordance with the configuration set by X when X set up Central Figure's system.

1) A method for navigating an interface of a computer program comprising the steps of:
a) a user being provided with one or more input means to a computer, the computer program being executed on the computer, and the user interacting with the interface of the computer program using the one or more input means;
b) the interface displaying one or more program options to the user, such program options being of a number manageable to the user, and each program option being represented by a readily identifiable program icon that enables navigation of the program options, the readily identifiable program icon being of a size substantially larger than a typical computer icon;
c) the user selecting at most one of the program options by selecting the corresponding readily identifiable program icon, the selected program option corresponding to one of a plurality of active programs, each active program represented by a consistent layout;
d) the interface displaying one or more basic commands to the user, such commands being of a number manageable to the user, each basic command relating to the active program, the basic commands each represented by a readily identifiable command icon, the readily identifiable command icon being of a size substantially larger than a typical computer icon; and
e) the user selecting at most one of the basic commands or returning to the display of the limited number of program options.

2) The method of claim 1 wherein the computer program is a web application.

3) The method of claim 1 wherein the computer program is an email client application that can receive and send messages, the email client application associated with an email address provided by a service provider.

4) The method of claim 1 wherein:
a) the active program contains more than one screen of information, navigation between the screens being provided by buttons corresponding to a next screen and a previous screen;
b) each of the readily identifiable program icons and each of the readily identifiable command icons is of a consistent size, shape, color, and caption font;
c) one of the input means is a mouse, each button of the mouse providing a common command; and
d) a plurality of buttons are provided to replace familiar concepts including menus; files; folders; windows; attachments; scroll bars; and launching computer programs.

5) The method of claim 3 wherein the reader of the email client application automatically blocks attachments of one or more files type from appearing in emails, files of other file types being displayed to the user as thumbnails which, when clicked, causes the interface to display the file to the user.

6) The method of claim 3 wherein the email client application embeds assistive text and command buttons at the beginning and end of each received email message and the email client application embeds date status messages at the beginning of each received email message.

7) The method of claim 3 wherein hyperlinks attached to received emails are automatically presented to the user as icons which, when clicked, causes the interface to present the web site associated with the hyperlink to the user using an internet browser.

8) The method of claim 3 wherein the user chooses to send a message, the user provided with an option to send a typed message or a voice message, or to initiate a voice conversation, video conversation or instant messaging conversation.

9) The method of claim 3 wherein an address selection means is preloaded with a library of images associated with the user's contacts, the user selecting a recipient of a sent message by selecting the recipient's image from the address selection means.

10) The method of claim 1 wherein direction from the user is provided by the interface presenting to the user a prompt answerable by only a positive or negative response.

11) The method of claim 1 wherein one of the program options is an emergency notification application, the emergency notification application operable to communicate with one or more other email users to alert the other email users of an emergency situation of the user.

12) A system for navigating an interface of a computer program comprising:
a) one or more input means to a computer, the computer program being executed on the computer, and a user interacting with the interface of the computer program using the one or more input means;
b) one or more program options displayed to the user by the interface, such program options being of a number manageable to the user, and each program option being represented by a readily identifiable program icon that enables navigation of the program options, the readily identifiable program icon being of a size substantially larger than a typical computer icon;
c) a plurality of active programs, each active program represented by a consistent layout, the user selecting at most one of the program options by selecting the corresponding readily identifiable program icon, the selected program option corresponding to one of active programs; and
d) one or more basic commands displayed to the user by the interface, such commands being of a number manageable to the user, each basic command relating to the active program, the basic commands each represented by a readily identifiable command icon, the readily identifiable command icon being of a size substantially larger than a typical computer icon;
wherein the user selects at most one of the basic commands or returns to the display of the limited number of program options.

13) The system of claim 12 wherein the computer program is an email client application that can receive and send messages, the email client application associated with an email address provided by a service provider.

14) The system of claim 12 wherein:
a) the active program contains more than one screen of information, navigation between the screens being provided by buttons corresponding to a next screen and a previous screen;
b) each of the readily identifiable program icons and each of the readily identifiable command icons is of a consistent size, shape, color, and caption font;
c) one of the input means is a mouse, each button of the mouse providing a common command; and
d) a plurality of buttons are provided to replace familiar concepts including menus;
files; folders; windows; attachments; scroll bars; and launching computer programs.

15) The system of claim 13 wherein the reader of the email client application automatically blocks attachments of one or more files type from appearing in emails, files of other file types being displayed to the user as thumbnails which, when clicked, causes the interface to display the file to the user.

16) The system of claim 13 wherein hyperlinks attached to received emails are automatically presented to the user as icons which, when clicked, causes the interface to present the web site associated with the hyperlink to the user using an internet browser.

17) The system of claim 13 wherein the user chooses to send a message, the user provided with an option to send a typed message or a voice message, or to initiate a voice conversation, video conversation or instant messaging conversation.

18) The system of claim 13 wherein an address selection means is preloaded with a library of images associated with the user's contacts, the user selecting a recipient of a sent message by selecting the recipient's image from the address selection.

19) A computer program product for navigating an interface of a computer program comprising:
a) a computer readable medium including software instructions; and
b) the software instructions for enabling the computer to perform predetermined operations, the predetermined operations including the steps of:
i) a user being provided with one or more input means to a computer, the computer program being executed on the computer, and the user interacting with the interface of the computer program using the one or more input means;
ii) the interface displaying one or more program options to the user, such program options being of a number manageable to the user, and each program option being represented by a readily identifiable program icon that enables navigation of the program options, the readily identifiable program icon being of a size substantially larger than a typical computer icon;
iii) the user selecting at most one of the program options by selecting the corresponding readily identifiable program icon, the selected program option corresponding to one of a plurality of active programs, each active program represented by a consistent layout;
iv) the interface displaying one or more basic commands to the user, such commands being of a number manageable to the user, each basic command relating to the active program, the basic commands each represented by a readily identifiable command icon, the readily identifiable command icon being of a size substantially larger than a typical computer icon; and
v) the user selecting at most one of the basic commands or returning to the display of the limited number of program options.

20) The computer program product of claim 19 wherein the computer program is a web application.

21) The computer program product of claim 19 wherein the computer program is an email client application that can receive and send messages, the email client application associated with an email address provided by a service provider.

22) The computer program product of claim 19 wherein:
a) the active program contains more than one screen of information, navigation between the screens being provided by buttons corresponding to a next screen and a previous screen;
b) each of the readily identifiable program icons and each of the readily identifiable command icons is of a consistent size, shape, color, and caption font;
c) one of the input means is a mouse, each button of the mouse providing a common command; and
d) a plurality of buttons are provided to replace familiar concepts including menus;
files; folders; windows; attachments; scroll bars; and launching computer programs.

23) The computer program product of claim 21 wherein the reader of the email client application automatically blocks attachments of one or more files type from appearing in emails, files of other file types being displayed to the user as thumbnails which, when clicked, causes the interface to display the file to the user.

24) The computer program product of claim 21 wherein hyperlinks attached to received emails are automatically presented to the user as icons which, when clicked, causes the interface to present the web site associated with the hyperlink to the user using an internet browser.

25) The computer program product of claim 21 wherein an address selection means is preloaded with a library of images associated with the user's contacts, the user selecting a recipient of a sent message by selecting the recipient's image from the address selection.

26) A system for distributing and remotely configuring a computer program comprising:
a) a server operated by a service provider, the server making available the computer program via remote download;
b) an enabling intermediary, familiar with a user, the enabling intermediary initiating a download of the computer program from the server, the enabling intermediary paying a fee to the service provider;
c) a first computer belonging to the user, the enabling intermediary installing the computer program on the first computer; and
d) a remote access utility enabling the enabling intermediary to remotely configure the computer program from a second computer.

27) The system of claim 26 wherein the computer program enables the use of a web-based utility used by the user.

28) The system of claim 26 wherein the enabling intermediary has knowledge of a supervisory password required to access the remote access utility.

29) The system of claim 26 wherein the enabling intermediary can remotely configure program settings of the computer program, the program settings including volume, font size, cursor size, keyboard enablement, boot loading, shutdown behavior, address book management, bookmark management, whitelisting, and blacklisting.

30) A method for distributing and remotely configuring a computer program comprising:
a) a server making available the computer program via remote download, the server operated by a service provider;
b) an enabling intermediary initiating a download of the computer program from the server, the enabling intermediary being familiar with a user, the enabling intermediary paying a fee to the service provider;
c) the enabling intermediary installing the computer program on a first computer, the first computer belonging to the user; and
d) the enabling intermediary remotely configuring the computer program from a second computer using a remote access utility.
